(19) United States
(12) Patent Application Publication
(10) Pub. No.: US 2024/0394527 A1
(43) Pub. Date: Nov. 28, 2024

(54) SYSTEMS AND METHODS FOR AUTOMATICALLY IDENTIFYING OUTLIERS IN A MACHINE LEARNING TRAINING DATASET

(71) Applicants: Constructor Autonomous AG, Schaffhausen (CH); Constructor Education and Research Genossenschaft, Schaffhausen (CH)

(72) Inventors: Andrei Boiarov, Sofia (BG); Igor Bykovskih, Istanbul (TR); Nikita Koritsky, Istanbul (TR); Ilya Shimchik, Istanbul (TR); Serg Bell, Singapore (SG); Stanislav Protasov, Singapore (SG); Nikolay Dobrovolskiy, Istanbul (TR); Sergey Ulasen, Singapore (SG)

(21) Appl. No.: 18/322,309

(22) Filed: May 23, 2023

(51) Int. Cl. G06N 3/08

(52) U.S. Cl. CPC G06N 3/08

(57) ABSTRACT

Systems and methods for automatically identifying outliers in Machine Learning training datasets. The method includes gaining access to a training set for the neural network NN. For each element of the training dataset, an embedding vector is generated, which is a numeric representation of the corresponding element. A centroid of all the embedding vectors of all the elements of the training set is computed equal to an average of all the embedding vectors of all the elements of the training set. A dissimilarity score is generated for each element of the training set by calculating a distance between the embedding vector corresponding to the element and the centroid. The method further includes identifying the elements from the training set with embedding vectors having the dissimilarity score higher than or equal to a predetermined threshold value.

### TECHNICAL FIELD

The present disclosure generally relates to the field of machine learning. In particular, the present disclosure relates to systems and methods for automatically identifying outliers in a machine learning training dataset.

### BACKGROUND

Training data is key to any machine learning model. For the effectiveness of a training data set, the amount of data and how clean the data plays an important role in maintaining accuracy for all machine learning algorithms. Training data sets are especially important for supervised learning models, which are trained on labelled datasets.

Due to the proliferation of data on the internet in recent times, it is necessary to make regular augmentations to the training datasets. In accordance with some typical implementations, large datasets are collected using automatic or automated tools, where large audiences assist in labelling efforts. These large efforts to produce learning sets that involve human intervention leading to introduction of human error or malicious disturbance. A disadvantageous aspect of such human intervention includes incorrectly labelled items in a dataset that affect the performance of the machine learning system trained on that dataset. Such a machine learning system will consequently produce skewed results, which is not desired. Manual review of every item in the learning dataset may solve the aforementioned disadvantageous aspect. However, such an endeavour is prohibitively expensive in terms of cost of human labor and time as in many cases learning sets need to be deployed within minutes or hours after collecting sufficient data.

Thus, there is a need for systems and methods to automatically identify smaller sets of items within the learning dataset that may be incorrectly labelled.

### SUMMARY

In an embodiment, the present disclosure describes a method for automatically identifying outliers in a training dataset for a neural network NN corresponding to a label. The method includes gaining access to a training set for the neural network NN. For each element of the training dataset, an embedding vector is generated, which is a numeric representation of the corresponding element. A centroid of all the embedding vectors of all the elements of the training set is computed equal to an average of all the embedding vectors of all the elements of the training set. A dissimilarity score is generated for each element of the training set by calculating a distance between the embedding vector corresponding to the element and the centroid. The method further includes identifying the elements from the training set with embedding vectors having the dissimilarity score higher than or equal to a predetermined threshold value.

In an embodiment, gaining access to the training set for the neural network NN includes gaining access to one or more user devices, databases, cluster storages, cloud storages, or databases.

In an embodiment, generating the embedding vectors further includes storing the embedding vectors, with metadata indicating a relationship of each of the elements of the training set to the corresponding embedding vectors.

In an embodiment, the method further includes a displaying to the user a list of the dissimilarity scores with visual representations of the elements of the training set.

In an embodiment, only the elements with the dissimilarity score higher than or equal to the predetermined threshold are displayed to the user on a monitor or other output device.

In an embodiment, the predetermined threshold value is configurable by the user using a graphical user interface.

In an embodiment, the method further includes refreshing a list of the elements and the corresponding dissimilarity scores displayed to the user in response to the user changing the predetermined threshold value using the graphical user interface.

In an embodiment, identifying the elements from the training set with the embedding vectors having the dissimilarity score higher than or equal to the predetermined threshold value further includes removing identified elements from the teaching dataset.

In an embodiment, the method further includes identifying if the new training set is sufficient to train the neural network NN based on at least one sufficiency criterion.

In an embodiment, the method includes generating at least one additional element using a generative convolutional neural network trained on the remaining training set and adding the at least one additional element to the training set if the training set is determined to be insufficient to train the neural network NN after the elements with dissimilarity score higher than or equal to the predefined threshold have been removed from the training set.

Embodiments described herein include a system for automatically identifying at least one outlier in a training set corresponding to a single label for a neural network. The system includes a data storage configured to store the training set. An embedding generator is configured to generate an embedding vector for each element of the training set which is a numeric representation of that element. A centroid generator is configured to compute a centroid of the elements equal to an average value for all the embedding vectors for all the elements from the training set. A dissimilarity score calculator is configured to calculate, for all the elements in the training set, a dissimilarity score, where the dissimilarity score equals to a distance between the embedding vector of the element and the centroid. An outlier selector is configured to identify elements from the training set such that the corresponding embedding vectors of the elements have the dissimilarity score higher than or equal to a predetermined threshold value.

In an embodiment, the data storage includes, databases, cluster storages, cloud storages, or databases.

In an embodiment, the embedding generator is further configured to store the embedding vectors, with metadata indicating the relationship of each of the elements of the training set to the corresponding embedding vector, for example, storing an offset of a video fragment corresponding to the embedding or the file name of the image corresponding to the embedding. Other types of metadata can also be utilized.

In an embodiment, the system further includes a visual output device configured to display to the user a list of the dissimilarity scores with visual representations of the elements of the training set.

In an embodiment, the visual output device is configured to only display the elements with the dissimilarity score higher than or equal to the predetermined threshold.

In an embodiment, the system further includes an input device configured to allow the user to configure the predetermined threshold using a graphical user interface.

In an embodiment, the visual output device is further configured to refresh the list of the elements and the corresponding dissimilarity scores displayed to the user in response to the user changing the predetermined threshold value.

In an embodiment, the outlier selector is further configured to remove the elements with dissimilarity score higher than or equal to the predefined threshold from the teaching dataset.

In an embodiment, the system further includes a sufficiency evaluator configured to identify if the training set is sufficient to train the neural network NN based on at least one sufficiency criterion after the elements with the dissimilarity score higher than or equal to the predetermined threshold are removed from the training set.

In an embodiment, the system further includes a data augmentation module configured to generate at least one additional element using a generative convolutional neural network trained on the remaining training set and adding the at least one additional element to the training set if the training set is determined to be insufficient to train the neural network NN after the elements with the dissimilarity score higher or higher or equal to the predefined threshold are removed from the training set.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of an environment for automatically identifying outliers in a machine learning training dataset, in accordance with an embodiment of the present disclosure.

FIG. 2 is a block diagram of a system for automatically identifying outliers in a machine learning training dataset, in accordance with another embodiment of the present disclosure.

FIG. 3 is a flowchart of method for automatically identifying outliers in a machine learning training dataset, in accordance with another embodiment of the present disclosure.

### DETAILED DESCRIPTION

Embodiments described herein include systems and methods for automatically identifying outliers in a machine learning training dataset. In an embodiment, the identification can be performed automatically, allowing human operators to minimize their involvement by manually removing from the training set elements that are dissimilar and do not belong in the dataset. An advantageous aspect of the system and method in accordance with the present disclosure is that the human intervention is mitigated to a great extent, as explained in the subsequent sections of the present disclosure.

In an embodiment, a metric learning method is used to train the neural network to calculate the dissimilarity score between embeddings of two images.

The metric learning method is an approach based directly on a distance metric that aims to establish similarity or dissimilarity between images.

In an embodiment, the metric learning method implements the Center Loss, Triplet Loss, Contrastive Loss, Softmax Loss, A-Softmax Loss, Large Margin Cosine Loss (LMCL), or Arcface Loss methods.

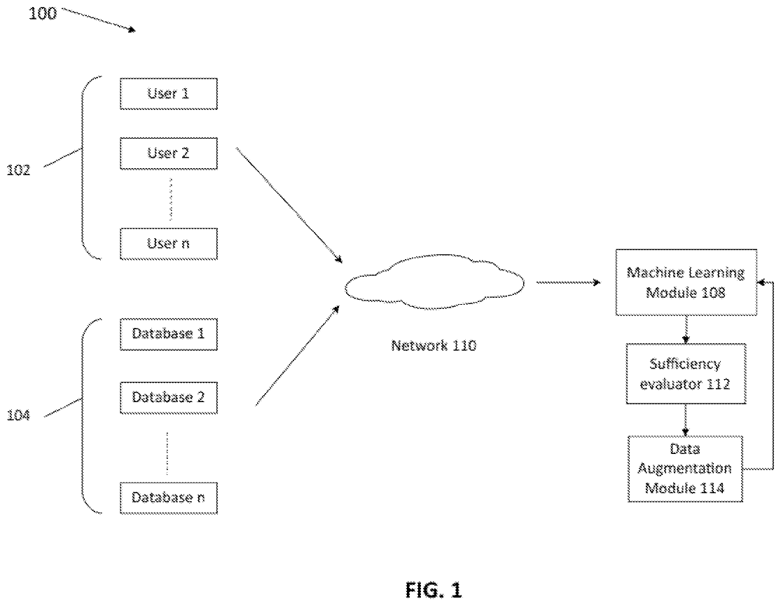

Referring to FIG. 1, a block diagram of an environment 100 for automatically identifying outliers in a machine learning training dataset, is shown in accordance with an embodiment of the present disclosure. The environment 100 includes a plurality of users 102 and a plurality of databases 104 connected to a machine learning module 108 by a network 110. In an embodiment, the network 110 can be the internet. The plurality of users 102 are the users of the machine learning module 108, while the plurality of databases 104 are the databases used for augmenting the machine learning module 108. As will be described, in certain embodiments, the machine learning module 108 can be augmented in real time.

The environment 100 further includes a sufficiency evaluator 112 and a data augmentation module 114. The operation of the sufficiency evaluator 112 and the data augmentation module 114 are explained in the subsequent sections of the present disclosure.

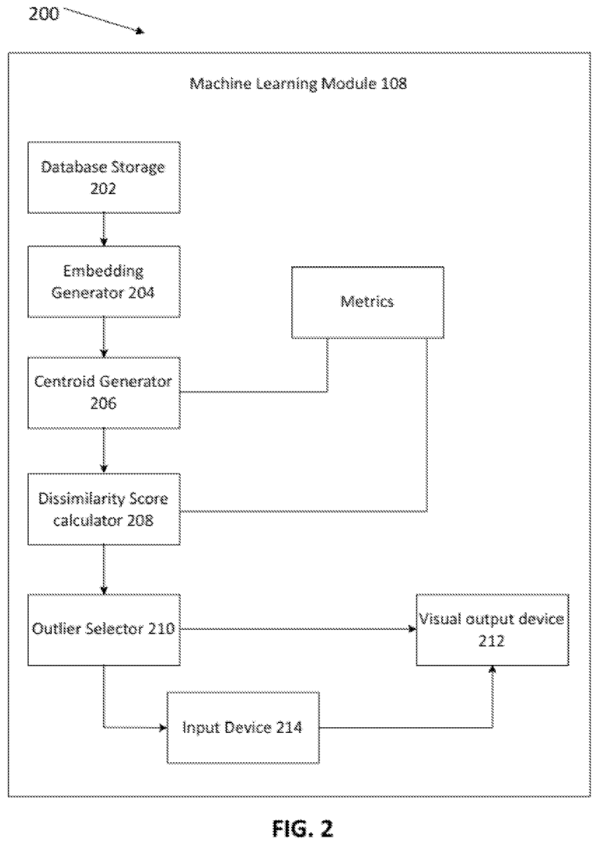

Referring to FIG. 2, a block diagram of a system 200 for automatically identifying outliers in a machine learning training dataset, is shown in accordance with another embodiment of the present disclosure. The system 200 includes a data storage 202 configured to store a training set for the machine learning module 108. As explained previously with respect to FIG. 1, the data storage 202 can be communicatively coupled to the plurality of databases 104 by the network 110. The data storage 202 can be updated and augmented as required or needed. Embodiments of system 200 can identify the most dissimilar elements to a label as an outlier for the training set within the data storage 202 for the purpose of further processing thereof.

The system 200 further includes an embedding generator 204. The embedding generator 204 is configured to generate an embedding vector for each element of the training set which is a numeric representation of that element. The numeric representation of the element is generated for the purpose of facilitating further processing thereof to detect if the element is an outlier for a particular label of the training set. In an embodiment, the embedding generator 204 is further configured to store the embedding vectors, with metadata indicating the relationship of each of the elements of the training set to the corresponding embedding vector, for example, storing an offset of a video fragment corresponding to the embedding or the file name of the image corresponding to the embedding.

The system 200 further includes a centroid generator 206 configured to compute a centroid of the elements equal to an average value for all the embedding vectors for all the elements from the training set. In embodiments, other algorithms to determine an item best representing the training data set can also be utilized.

The system 200 further includes a dissimilarity score calculator 208 configured to calculate, for all the elements in the training set, a dissimilarity score. In an embodiment, the dissimilarity score equals to a distance between the embedding vector of the element and the centroid. In embodiments, other functions equivalent to a distance at least for vectors located far from the centroid can also be utilized. More specifically, the embedded generator 204 generates the embedding vector for the element, and the embedding vector for the element is then compared to the centroid generated by the centroid generator 206, where such a comparison between the embedding vector and the centroid is facilitated by the dissimilarity score calculator 208, which also assigns the dissimilarity score to the element.

In one embodiment, a high dissimilarity score can indicate that the element may be an outlier for the training set. The system 200 further includes outlier selector 210 configured to identify elements from the training set such that the corresponding embedding vectors of the elements have the dissimilarity score higher than or equal to a predetermined threshold value. In another embodiment, the threshold value can be user-defined. In another embodiment, the threshold value can be dynamically-generated based on historical data.

In an embodiment, the system 200 can further include a removal module configured to remove all the elements from the training set with a dissimilarity score higher than or equal to the predetermined threshold value.

In another embodiment, the system 200 can further include a human review module configured to display all items from the training set with the dissimilarity score higher than or equal to the predetermined threshold value and give a human operator a user interface to make changes to the dissimilar elements including removing them from the training set or changing the score. More specifically, the system 200 further includes a visual output device 212 configured to display to the user a list of the dissimilarity scores with visual representations of the elements of the training set. The visual output device 212 can be further configured to only display the elements with the dissimilarity score higher than or equal to the predetermined threshold.

The system 200 further includes an input device 214 configured to allow the user to configure the predetermined threshold using a graphical user interface. The visual output device 212 can be further configured to refresh the list of the elements and the corresponding dissimilarity scores displayed to the user in response to the user changing the predetermined threshold value.

Referring again to FIG. 1, in an embodiment, the system can further include the sufficiency evaluator 112 and the data augmentation module 114. After the removal of the outliers from the training set of machine learning module 108, the sufficiency evaluator 112 is configured to identify if the training set is sufficient to train the neural network NN based on at least one sufficiency criterion after the elements with the dissimilarity score higher than or equal to the predetermined threshold are removed from the training set. The sufficiency criterion can be based in modern complex systems on the heuristic analysis of known systems of similar nature and similar number of degrees of freedom of NN. For example, the heuristic rule may determine that the model requires N*D or D², where D is the number of degrees of freedom of the neural network, and N is a number.

The data augmentation module 114 is configured to generate at least one additional element of the training set, for example, an image or a video fragment, using a generative convolutional neural network trained on the remaining training set and adding the at least one additional element to the training set if the training set is determined to be insufficient to train the neural network NN after the elements with the dissimilarity score higher or higher or equal to the predefined threshold are removed from the training set.

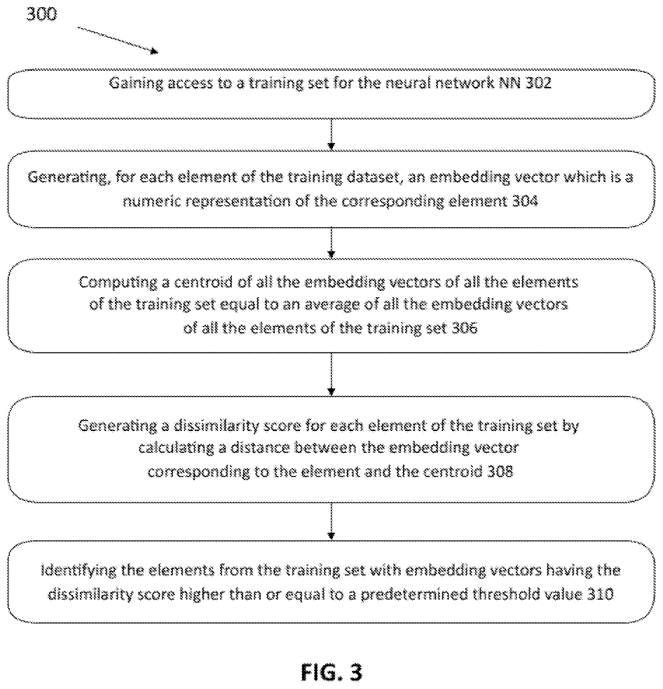

Referring to FIG. 3, a block diagram of a method 300 for automatically identifying outliers in a machine learning training dataset is shown, in accordance with another embodiment of the present disclosure.

At block 302, the method 300 includes gaining access to a training set for the neural network NN. In an embodiment, gaining access to the training set for the neural network NN includes gaining access to one or more user devices, databases, cluster storages, cloud storages, or databases.

At block 304, the method 300 includes generating, for each element of the training dataset, an embedding vector which is a numeric representation of the corresponding element. In embodiment, generating the embedding vector can be performed by the embedding vector generator 204. In an embodiment, generating the embedding vectors further includes storing the embedding vectors, with metadata indicating a relationship of each of the elements of the training set to the corresponding embedding vectors, for example, storing an offset of a video fragment corresponding to the embedding or the file name of the image corresponding to the embedding.

At block 306, the method 300 includes computing a centroid of all the embedding vectors of all the elements of the training set equal to an average of all the embedding vectors of all the elements of the training set. In an embodiment, computing the centroid can be performed by the centroid generator 206.

At block 308, the method 300 further includes generating a dissimilarity score for each element of the training set by calculating a distance between the embedding vector corresponding to the element and the centroid. In an embodiment, generating the dissimilarity score is performed by the centroid generator 206.

At block 310, the method 300 includes identifying the elements from the training set with embedding vectors having the dissimilarity score higher than or equal to a predetermined threshold value. In an embodiment, the aforementioned identifying is performed by the outlier selector.

In an embodiment, the method 300 further includes displaying to the user a list of the dissimilarity scores with visual representations of the elements of the training set. In an embodiment, displaying is facilitated by the visual output device 212.

In an embodiment, the method 300 further includes displaying only the elements with the dissimilarity score higher than or equal to the predetermined threshold are displayed to the user on a monitor or other output device. In an embodiment, displaying is facilitated by the visual output device 212.

In an embodiment of the method 300, the predetermined threshold value is configurable by the user using a graphical user interface. In an embodiment, the input device 214 can facilitate the reconfiguration of the predetermined threshold value by the graphical user interface.

In an embodiment, the method 300 further includes refreshing a list of the elements and the corresponding dissimilarity scores displayed to the user in response to the user changing the predetermined threshold value using the graphical user interface. In an embodiment, the refreshed list can be presented to the user using the visual output device 212.

In an embodiment of the method 300, identifying the elements from the training set with the embedding vectors having the dissimilarity score higher than or equal to the predetermined threshold value further includes removing identified elements from the teaching dataset. In an embodiment, removing the identified elements or outliers from the training set can be performed by the removal module.

In an embodiment, the method 300 further includes identifying if the new training set is sufficient to train the neural network NN based on at least one sufficiency criterion. In an embodiment, the sufficiency evaluator 112 performs the aforementioned identifying.

In an embodiment, the method 300 further includes generating at least one additional element using a generative convolutional neural network trained on the remaining training set and adding the at least one additional element to the training set if the training set is determined to be insufficient to train the neural network NN after the elements with dissimilarity score higher than or equal to the predefined threshold have been removed from the training set. In an embodiment, the data augmentation module 114 performs the aforementioned generating.

1. A method for automatically identifying outliers in a training dataset for a neural network NN corresponding to a label, the method comprising:
gaining access to the training set for the neural network NN comprising a plurality of elements;
generating, for each element of the training dataset, an embedding vector which is a numeric representation of the corresponding element;
computing a centroid of all the embedding vectors of all the elements of the training set equal to an average of all the embedding vectors of all the elements of the training set;
generating a dissimilarity score for each element of the training set by calculating a distance between the embedding vector corresponding to the element and the centroid; and
marking the elements from the training set with embedding vectors having the dissimilarity score higher than or equal to a predetermined threshold value as outliers.

2. The method of claim 1, wherein the dissimilarity score for each element is calculated using a neural network trained using a metric learning method.

3. The method of claim 2, wherein the metric learning method implements at least one of a Center Loss, Triplet Loss, Contrastive Loss, Softmax Loss, A-Softmax Loss, Large Margin Cosine Loss (LMCL), or Arcface Loss methods.

4. The method of claim 1, wherein the gaining access to the training set for the neural network NN comprises gaining access to one or more user devices, databases, cluster storages, cloud storages, or databases.

5. The method of claim 1, wherein generating the embedding vectors further comprises storing the embedding vectors, with metadata indicating a relationship of each of the elements of the training set to the corresponding embedding vectors.

6. The method of claim 1, further comprising:
displaying a list of the dissimilarity scores with visual representations of the elements of the training set.

7. The method of claim 1, wherein the predetermined threshold value is configurable by using a graphical user interface.

8. The method of claim 7, further comprising:
refreshing a list of the elements and the corresponding dissimilarity scores displayed in response to the user changing the predetermined threshold value using the graphical user interface.

9. The method of claim 1, wherein the marking the elements from the training set with the embedding vectors having the dissimilarity score higher than or equal to the predetermined threshold value further comprises removing marked elements from the training set.

10. The method of claim 9, further comprising:
identifying if the training set with removed marked elements is sufficient to train the neural network NN based on at least one sufficiency criterion.

11. The method of claim 10, further comprising:
generating at least one additional element using a generative convolutional neural network trained on the remaining training set and adding the at least one additional element to the training set if the training set is determined to be insufficient to train the neural network NN after the elements with dissimilarity score higher than or equal to the predefined threshold have been removed from the training set.

12. A system for automatically identifying at least one outlier in a training set corresponding to a label for a neural network, comprising:
a data storage configured to store the training set;
an embedding generator configured to generate an embedding vector for each element of the training set which is a numeric representation of that element;
a centroid generator configured to compute a centroid of the elements equal to an average value for all the embedding vectors for all the elements from the training set;
a dissimilarity score calculator configured to calculate, for all the elements in the training set, a dissimilarity score, wherein the dissimilarity score equals to a distance between the embedding vector of the element and the centroid; and
an outlier selector configured to identify and to mark elements from the training set such that the corresponding embedding vectors of the elements have the dissimilarity score higher than or equal to a predetermined threshold value.

13. The system of claim 12, wherein the data storage comprises one or more devices, databases, cluster storages, cloud storages, or databases.

14. The system of claim 12, wherein the embedding generator is further configured to store the embedding vectors, with metadata indicating the relationship of each of the elements of the training set to the corresponding embedding vector.

15. The system of claim 12, further comprising:
a visual output device configured to display a list of the dissimilarity scores with visual representations of the elements of the training set.

16. The system of claim 12, further comprising:
an input device configured to allow the user to configure the predetermined threshold using a graphical user interface.

17. The system of claim 16, wherein the visual output device is further configured to refresh the list of the elements and the corresponding dissimilarity scores displayed to the user in response to changing the predetermined threshold value.

18. The system of claim 12, wherein the outlier selector is further configured to remove the elements with dissimilarity score higher than or equal to the predefined threshold from the training set.

19. The system of claim 18, further comprising:
a sufficiency evaluator configured to identify if the training set is sufficient to train the neural network NN based on at least one sufficiency criterion after the elements with the dissimilarity score higher than or equal to the predetermined threshold are removed from the training set.

20. The system of claim 19, further comprising:
a data augmentation module configured to generate at least one additional element using a generative convolutional neural network trained on the remaining training set and adding the at least one additional element to the training set if the training set is determined to be insufficient to train the neural network NN after the elements with the dissimilarity score higher or higher or equal to the predefined threshold are removed from the training set.
